(19) United States
(12) Patent Application Publication
(10) Pub. No.: US 2010/0247861 A1
(43) Pub. Date: Sep. 30, 2010

(54) ENGINEERED ENVIRONMENTALLY FRIENDLY FLOORING

(76) Inventor: Daniel Paul Mitchell, Cedar Rapids, IA (US)

Correspondence Address: Daniel P. Mitchell, 50 Walford rd, Cedar Rapids, IA, 52404, US

(21) Appl. No.: 12/711,579

(22) Filed: Feb. 24, 2010

Related U.S. Application Data
(60) Provisional application No. 61/202,378, filed on Feb. 24, 2009.

(51) Int. Cl. B32B 21/04; B32B 7/02; B32B 3/02

(52) U.S. Cl. 428/142; 428/215; 428/193

(57) ABSTRACT

An engineered flooring product having a top wear layer of solid hard wood, which is connected to a bamboo composite substrate (lower layer) therein. Each length and width has a unique tongue and groove system and results in an interlocking system on all sides. Since the substrate is made of bamboo it is environmentally friendly and stronger than hardwoods.

### FIELD OF THE INVENTION

The present invention relates to a flooring product, and preferably to environmentally friendly flooring products, having a minimum top wear layer of traditional/exotic hardwood plank and a ecologically friendly substrate composed of a solid bamboo composite (strand woven) with an innovative interlocking T&G floating floor system called Wood-Boo-Too.

### DESCRIPTION OF RELATED ART

Bamboo is a rapidly replenishable asset. There are over a thousand species of perennial, woody, usually shrubby or treelike plants of the grass family. Bamboo usually grows in tropical and subtropical areas from sea level to snow capped mountain peaks. Some species reach to temperate areas. The species are most abundant in southeastern Asia. The various species can range from stiff reeds of about one meter tall to giants reaching as high as eighty feet in height.

One particular species called hairy bamboo has been found to grow up to eighty feet tall and up to ten inches in diameter at the base within a four to six year window.

The lower fifteen to twenty percent of the bamboo stock is the thickest outer wall portion and makes an excellent component for wood products. While planks from this section are very dense and heavy, these planks make an ideal component for flooring.

It has been noted that the hairy bamboo species is harder than northern red oak. Furthermore, it is more stable and resistant to movement caused by moisture than most other wood products. Furthermore, it has a tensile compression strength superior to some steel. Finally, it has been found to have a weight to strength ratio surpassing that of graphite, making bamboo the strongest growing woody plant on earth.

By recognizing the structural characteristics of bamboo, manufacturers have developed a number of bamboo flooring products, which have been sold in the United States and the world for a number of years.

### DETAILED DESCRIPTION OF THE EMBODIMENT

The hardwood wear layer referred to in Paragraph [0001] is believed to be an improvement over the strand woven design because of its versatility in appearance. Strand Woven composite is a process in which the bamboo strands are separated from one another and then dipped in a pressure and heat sensitive solution and then drip-dried to the touch. They are then heated in a conveyer oven to reduce the moisture content. The bamboo strands are then placed into the pressing machine that compiles 36 inches of the bamboo strand materials that are compressed and intertwined into 6 inch high by 6 inch wide by 6 foot long blocks that are then subjected to heat to form a solid block of material. The solid blocks are then ripped into boards and then turned into lumber or finished planks.

While strand woven bamboo provides a beautiful and sturdy flooring product, they do not have the look of white oak, Brazilian cherry, Burma teak, black walnut, Chinese red maple, African mahogany, Kumaru, Merbau, Oaken, Asian Kulim, African Tiger Wood, Masserand Duba, African Kuku, and various combinations of stains, and other woods which have been utilized for flooring in the United States and around the world over the years.

While solid wood flooring is currently an option, solid wood flooring by its very nature requires the entire thickness of the flooring plank to be constructed of a single species such as white oak, Brazilian cherry, Burma teak, black walnut, Chinese red maple, African mahogany, Kumaru, Merbau, Oaken, Asian Kulim, African Tiger Wood, Masserand Duba, African Kuku, and various combinations of stains. This can result in the usage of a significant amount of raw material thereby depleting the forests at a relatively rapid rate.

Accordingly, there is believed to be the need to provide a traditional looking floor product while more efficiently utilizing these less replenishable natural resources.

What is consistent about traditional bamboo-flooring products is that they use only bamboo as the source of wood.

### SUMMARY OF THE INVENTION

It is an object of the present invention to provide a traditional looking wood product, which is engineered to provide an environmentally friendlier product than traditional solid wood products.

It is another object of the present invention to provide an improved engineered flooring product.

Accordingly, in the present invention, the engineered wood product is comprised of the top layer, a solid wood product. This wear layer is a continuous piece taken from a single board, which spans the width and length of the plank. Below the top layer is a substrate of engineered material taken from the bamboo strand woven board. In the presently preferred embodiment, the substrate is bamboo with the top hardwood wear layer connected thereto. Additionally, the unique tongue and groove flooring product plank is preferably constructed different than other traditional flooring tongue and groove design.

### BRIEF DESCRIPTION OF THE DRAWINGS

FIG. 1 is a perspective view of a flooring product according to the present invention.

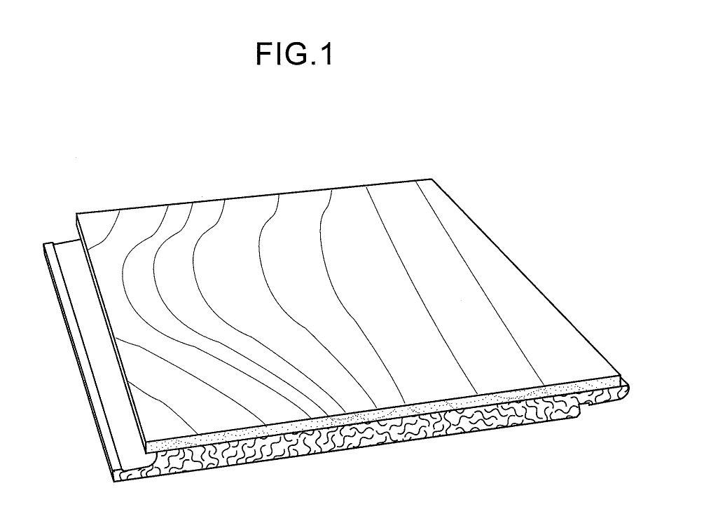

FIG. 2 is another perspective view of a flooring product according to the present invention.

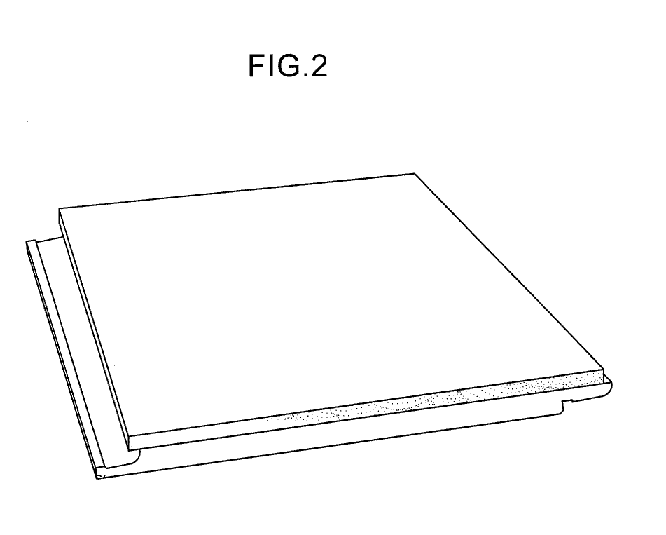

FIG. 3 is another perspective view of a flooring product according to the present invention.

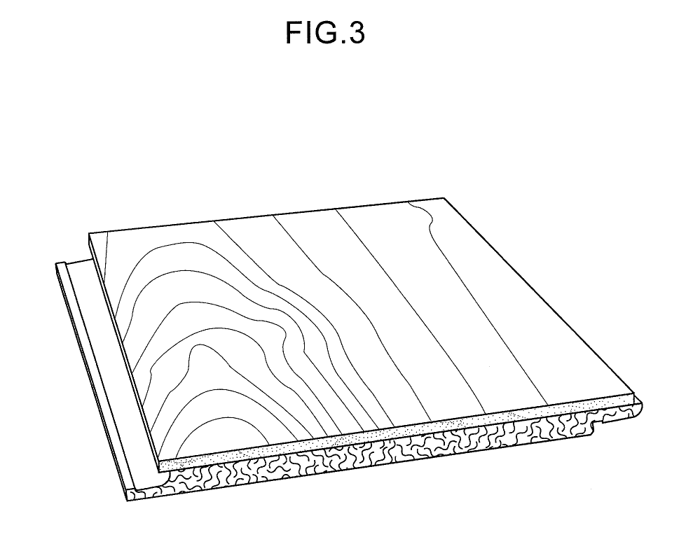

FIG. 4 is a detailed perspective view of a flooring product according to the present invention.

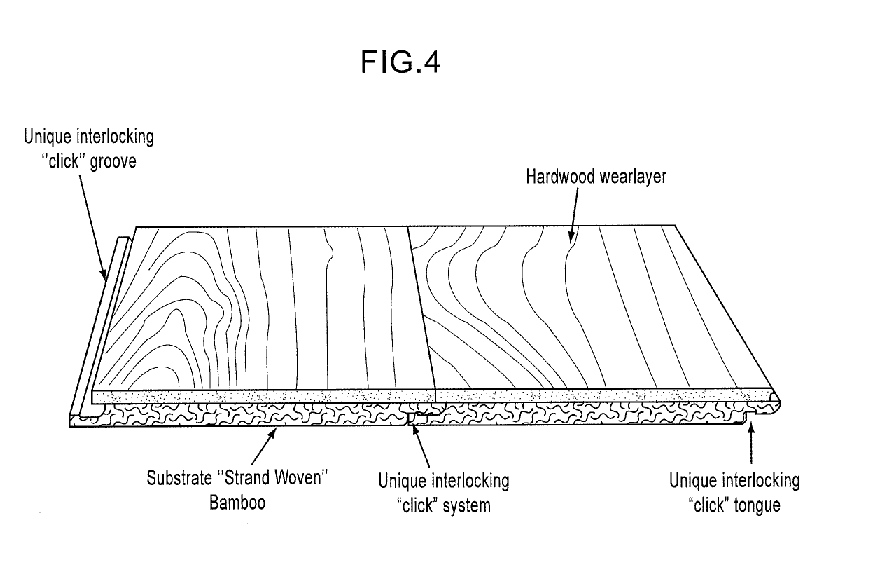

### BRIEF DESCRIPTION OF THE FLOORING

See Paragraph [0001]

The first layer will have a maximum thickness of 5 mm and a minimum thickness of 2.5 mm. The length and the width of the hardwood wear layer will be a continuous plank. It is anticipated that the hardwood wear layer will be a continuous slab of wood cut from a tree and then connected to a substrate.

Bamboo for the body of the substrate has been found particularly attractive since bamboo is a rapidly replenishing resource with a majority of the bamboo utilized for such a product grown and harvested in a five year or less period.

The invention is comprised of a hardwood wear layer which has a minimum thickness of 2.5 mm and a maximum thickness of 5 mm. The substrate (strand woven—see Paragraph [0007]) is 7.5 mm to 12 mm. They are connected with a non-toxic formaldehyde free heat/pressure sensitive bonded adhesive. The overall thickness is 10 mm or 15 mm.

To date, no other company has produced an engineering flooring with a first layer of a wood with a substrate being a composite bamboo. This substrate is a bamboo composite product with the first layer being hardwood face connected thereto.

Also, it is worth observing the first layer is essentially rectangular and the length is perpendicular to the width, which is perpendicular to the thickness.

Numerous alterations of the structure herein disclosed will suggest themselves to those skilled in the art. However, it is to be understood that the present disclosure related to the preferred embodiment of the invention, which is for purposes of illustration only, and not to be construed as a limitation of the invention. All such modifications, which do not depart from the spirit of the invention, are intended to be included within the scope of the appended claims.

Having thus set forth the nature of the invention, what is claimed herein is:

1. A wood product comprising of:
a first layer (top wear layer) is comprised of a minimum thickness of 2.5 mm and a maximum thickness of 5 mm of a hardwood, and are based on a 7.5 mm or 12 mm solid bamboo composite lower layer; and
the substrate is comprised of a solid composite bamboo (strand woven—see [0007]), which is connected with a non-toxic formaldehyde free heat/pressure sensitive bonded adhesive, and the thickness of the lower level bamboo composite is 12 mm.

2. The wood product according to claim 1, wherein an alternative to the 15 mm is a 10 mm overall thickness with a 7.5 mm solid composite bamboo substrate (strand woven—see [0007]) and a 2.5 mm continuous hardwood wear layer.

3. The wood product according to claim 1, further comprising:
a finish coating applied to the top surface of the hardwood, wherein the finish coating is a heat activated coating with ceramic particles in the finish, with multiple layers of clear filler coating over the ceramic particles, there being seven combined layers of UV finish on the top wear layer which is a hardwood surface.

4. The wood product according to claim 1, further comprising:
an interlocking system having a unique tongue going into a unique groove of a next board, wherein on the end of the length of the plank (width) there is also a unique groove or unique tongue recipient, which is designed to make all four sides interlocking, wherein one length and one width of each board bears the unique groove and the opposite length and width bears the unique tongue.

5. The wood product according to claim 1, wherein the top wear layer is selected from the group of hardwoods which consist of but are not limited to the following: white oak, Brazilian cherry, Burma teak, black walnut, Chinese red maple, African mahogany, Kumaru, Merbau, Oaken, Asian Kulim, African Tiger Wood, Masserand Duba, African Kuku, and various combinations of stains.

6. The wood product according to claim 1, wherein the hardwood chosen for the wear layer from 2.5 mm to 5 mm thickness, is a continuous piece of wood, both width and length.

7. A flooring product, comprising:
a precision cut of a solid hardwood wear layer selected from the group of those listed in claim 5; and
a substrate comprised of a solid bamboo composite connected to the first layer and located below the first layer.
